(19) United States
(12) Patent Application Publication
(10) Pub. No.: US 2004/0036905 A1
(43) Pub. Date: Feb. 26, 2004

(54) Multi-function printer

(76) Inventor: Chin Chi Chang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/224,642

(22) Filed: Aug. 21, 2002

(51) Int. Cl. G06F 15/00; B41F 1/00; H04N 1/00

(52) U.S. Cl. 358/1.15; 358/402

(57) ABSTRACT

A multi-function printer comprises a central processing unit (CPU), an image scanning unit, a printing output unit, a data transmitting unit. All units are electrically connected with a communication interface bus for data transmit, the operations of printing, scanning, faxing, and coping are controlled by the CPU. The multi-function printer further comprises an Internet interface unit connected with the bus and further connected to LAN or Internet network for doing data exchange with computers connected with the network. A data storage unit is connected with the bus used to store input data from the image scanning unit, the data transmitting unit, or the Internet interface unit in file format. A human-machine operation interface is connected with the bus for operating scan, print, fax, or scan functions directly on the multi-function printer and implementing addition, correction, deletion, and setting for sharing the file data stored in the data storage unit.

### BACKGROUND OF THE INVENTION

1. Field of the Invention

The present invention relates generally to printers and facsimile devices, and more particularly to a multi-function printer (MFP) capable of connecting the Internet/intranet thereby implementing document sharing on the Internet/intranet. Further, the documents can be managed directly through the MFP.

2. Description of the Prior Art

Multi-function facsimile devices (i.e., fax machines) have been used for years to transmit documents containing text or graphical images through a modem via telephone lines through another modem to a remote destination. Such multi-function fax machines act primarily as both a sender (i.e., scanning and transmitting) and receiver of documents, and that the multi-function fax machines also act as a printer (i.e., printing a facsimile, printing a copy of a scanned document, or printing an itemized report) and secondarily as a convenience copier (i.e., scanning/printing a document). Since the multi-function fax machines, sometimes also referred to as a multi-function printer (MFP), can provide many functions as described above, they are very popular to enterprises, small offices, or home workers (SOHO).

However, currently used multi-function printers do not have capability in connecting the Internet/intranet. Moreover, the prior art multi-function printers cannot implement document management itself.

### SUMMARY OF THE INVENTION

The main objective of the invention is to provide an improved multi-function printer capable of implementing Internet document sharing function.

The above object will be achieved by the multi-function printer in the present invention which at least comprises a central processing unit (CPU), an image scanning unit, a printing output unit, a data transmitting unit, all units are electrically connected with-a communication interface bus for data transmit, the operations of printing, scanning, faxing, and coping are controlled by the CPU. The multi-function printer further comprises an Internet interface unit connected with the bus and further connected to LAN or Internet network and is capable of doing data exchange with computers connected with the network. A data storage unit is connected with the bus used to store input data from the image scanning unit, the data transmitting unit, or the Internet interface unit in file format. A human-machine operation interface is connected with the bus for operating scan, print, fax, or scan functions directly on the multi-function printer and implementing addition, correction, deletion, and setting for sharing the file data stored in the data storage unit.

In accordance with one aspect of the present invention, a document management method for a multi-function printer capable of implementing Internet document sharing function is provided. The method comprises the steps of (a). setting protocol between the connected computer and the multi-function printer; (b). setting paper format of document data; (c). inputting document data and storing a new file that combined with the paper format in step b; (d). continue to implement steps (b) and (c) till the end of file data input; and (e). implementing operation functions: print, fax, scan, or copy, or management functions: correction, deletion, and sharing.

Other objects, advantages and novel features of the invention will become more clearly and readily apparent from the following detailed description when taken in conjunction with the accompanying drawings.

### BRIEF DESCRIPTION OF THE DRAWINGS

FIG. 1 is a block diagram illustrating the hardware of the multi-function printer according to the present invention.

FIG. 2 is a typical page of the web browser for managing file data of the multi-function printer according to the present invention.

FIG. 3 is a flow chart showing the method of file managing the multi-function printer according to the present invention.

### DETAILED DESCRIPTION OF THE PREFERRED EMBODIMENT

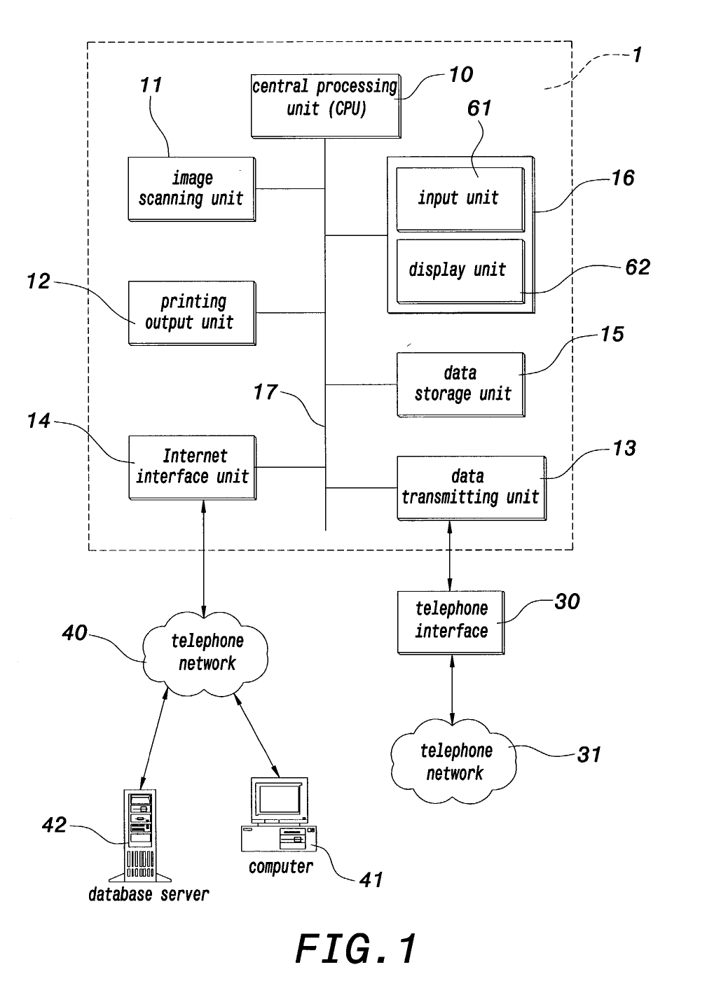

Now, one embodiment of the present invention will be explained below with reference to the drawings. Please refer to FIG. 1 of block diagram illustrating the hardware of the multi-function printer according to the present invention. The multi-function printer 1 of the present invention at least comprises a central processing unit (CPU) 10, an image scanning unit 11, a printing output unit 12, a data transmitting unit 13, an Internet interface unit 14, a data storage unit 15, and a human-machine operation interface 16. All units are electrically connected with a communication interface bus 17 for data transmit. The CPU 10 is the control center according to the present invention. The image scanning unit 11 is used to scan image on an input paper document. The printing output unit 12 is used to output the printing data. The printing output unit 12 and the image scanning unit 11 together can implement copy function. The data transmitting unit 13 is comprised of a telephone interface 30 connected to a telephone network 31. The data transmitting unit 13 and the image scanning unit 11 together can implement fax sending function. The data transmitting unit 13 and the printing output unit 12 together can implement fax receiving function.

The Internet interface unit 14 is connected with a data network 40 such as a LAN or Internet and is capable of doing data exchange with computers connected with the network 40. The data storage unit 15 is used to store input data from the image scanning unit 11, the data transmitting unit 13, or the Internet interface unit 14 in file format. For example, the data storage unit 15 may be a hard disk, CD drive such as CD-RW, DVD-RAM, or the like, or nonvolatile storage medium such as a flash memory.

The human-machine operation interface 16 at least comprises an input unit 61 and a display unit 62, which facilitates the user to operate scan, print, fax, or scan functions directly on the multi-function printer 1 and to implement addition, correction, deletion, and setting for sharing the file data stored in the data storage unit 15. The input unit 61 may be a control keypad for setting and managing the files stored in the data storage unit 15. The display unit 62, which functions as a subsidiary tool for the file management of the input unit 61, is used to display files stored in the data storage unit 15.

Capitalizing on the Internet interface unit 14, the computer 41 connected to the Internet can control or operate the multi-function printer 1, whereby the computer 41 can directly set and manage the file data stored in the data storage unit 15. Of course, the computer may be a database server 42 that is capable of storing much more data.

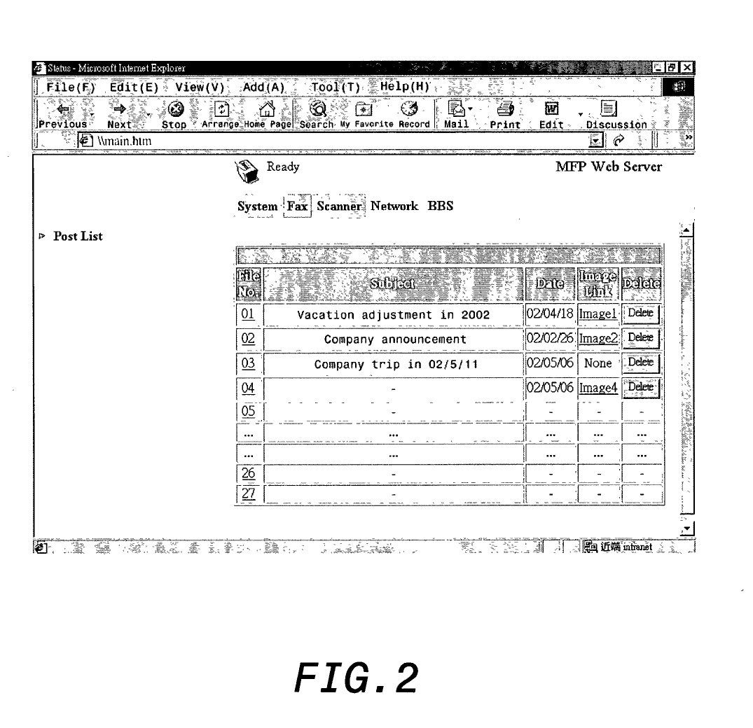

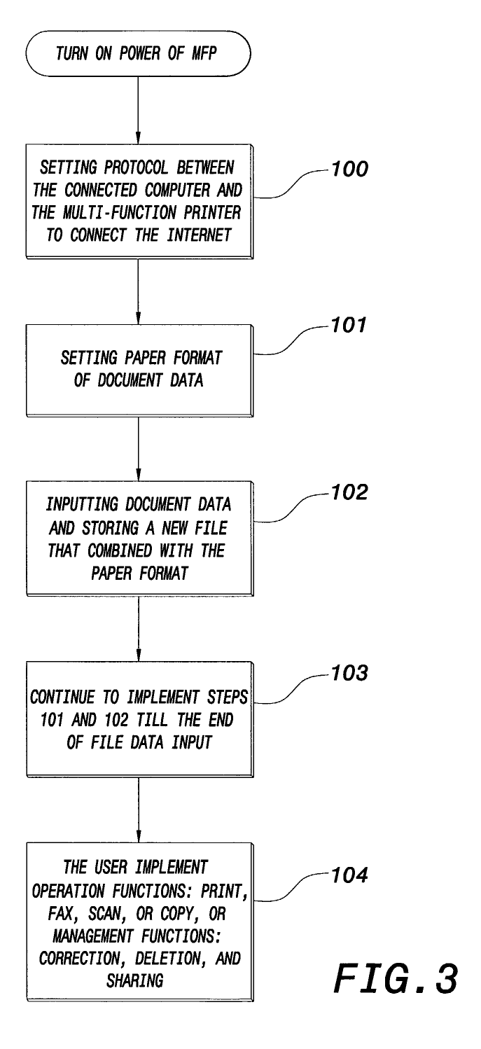

Further, the operations of displaying and managing the file data may be accomplished by web browser of the computer 41 connected to the Internet interface unit 14. Please refer to FIG. 2 and FIG. 3. FIG. 2 is a typical page of the web browser for managing file data of the multi-function printer 1 according to the present-invention. FIG. 3 is a flow chart showing the method of file-managing the multi-function printer 1 according to the present invention. First, when the power of the multi-function printer 1 is turned on, settings relating to protocol between the connected computer 41 and the multi-function printer 1 are input such that the multi-function printer 1 can connect the data network 40 such as LAN or Internet, thereby permitting- data exchange between the computer and the multi-function printer 1 (step 100). The protocol comprises TCP/IP, IPX/SPX, or Net BEUI, etc.

Next, the file format of the document is determined and input (step 101). The file format may include files number (Files No.) 200, Subject 201, Date 202, or Image Address 203, etc, as shown in FIG. 2. Then, the document to be faxed is delivered into the multi-function printer 1 either based on the scan function or based on the fax receiving function, or input through the computer 41 connected to the multi-function printer 1. The input document data combined with the file data previously determined in the multi-function printer 1 are stored together into a new file (step 102).

The step of determining and inputting the file format of the document and then the step of document input and new file storage till the end of document inputting (step 103). At this phase, at least one file is stored in the data storage unit 15. And the file list record can be seen on web browser as illustrated in FIG. 2.

Finally, the user can operate printing, faxing, coping functions directly through the multi-function printer 1, or implement management actions such as file deletion, correction, and sharing settings. Or, he can operate above described actions or management through the computer 41 connected to the multi-function printer 1.

It is to be understood however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A multi-function printer capable of implementing Internet document sharing function, the multi-function printer at least comprising a central processing unit (CPU), an image scanning unit, a printing output unit, a data transmitting unit, all units being electrically connected with a communication interface bus for data transmit, the operations of printing, scanning, faxing, and coping being controlled by the CPU, the multi-function printer further comprising:
an Internet interface unit connected with the bus and further connected to LAN or Internet network and is capable of doing data exchange with computers connected with the network;
a data storage unit connected with the bus used to store input data from the image scanning unit, the data transmitting unit, or the Internet interface unit in file format; and
a human-machine operation interface connected with the bus for operating scan, print, fax, or scan functions directly on the- multi-function printer and implementing addition, correction, deletion, and setting for sharing the file data stored in the data storage unit.

2. The multi-function printer as claimed in claim 1 wherein the file data stored in the data storage unit can be directly managed by means of the computer connected to the Internet, interface unit.

3. The multi-function printer as claimed in claim 2 wherein the file data are displayed and managed by web browser of the computer connected to the Internet interface unit.

4. The multi-function printer as claimed in claim 2 wherein the computer is a database server.

5. The multi-function printer as claimed in claim 1 wherein the data storage unit is one of hard disk, CD drive, CD-RW, DVD-RAM, nonvolatile storage medium, and flash memory.

6. The multi-function printer as claimed in claim 1 wherein the human-machine operation interface further comprising:
an input unit, which is a control keypad for setting and managing the files stored in the data storage unit; and
a display unit, which functions as a subsidiary tool for the file management of the input unit, being used to display files stored in the data storage unit.

7. A document management method for a multi-function printer capable of implementing Internet document sharing function, the multi-function printer is capable of implementing scan, print, fax, and copy functions, and connecting at least a computer on a network, the method at least comprising the steps of:
(a). setting protocol between the connected computer and the multi-function printer;
(b). setting paper format of document data;
(c). inputting document data and storing a new file that combined with the paper format instep b;
(d). repeating steps (b) and (c) till the end of file data input; and
(e). implementing operation functions: print, fax, scan, or copy, or management functions: correction, deletion, and sharing.

8. The method as claimed in claim 7 wherein the protocol in step (a) includes TCP/IP, IPX/SPX, and Net BEUI.

9. The method as claimed in claim 7 wherein the file data in step (b) at least comprise files number (Files No.), Subject, Date, and Image Address.

10. The method as claimed in claim 7 wherein inputting document data in step (c) is accomplished by using the scan function of the multi-function printer.

11. The method as claimed in claim 7 wherein inputting document data in step (c) is accomplished by using the fax receiving function of the multi-function printer.

12. The method as claimed in claim 7 wherein inputting document data in step (c) is accomplished by transferring data from the computer on the network.

13. The method as claimed in claim 7 wherein in step (e), operation functions: print, fax, scan, or copy, are accomplished by directly using the multi-function printer.

14. The method as claimed in claim 7 wherein in step (e), management functions: correction, deletion, and sharing, are accomplished by using the computer on the network.

15. The method as claimed in claim 14 wherein in step (e), management functions: correction, deletion, and sharing, are accomplished by using web browser of the computer on the network.
